(19) United States
(12) Patent Application Publication
(10) Pub. No.: US 2011/0227409 A1
(43) Pub. Date: Sep. 22, 2011

(54) RELAY AND POWER SUPPLY APPARATUS FOR VEHICLE

(75) Inventors: Shigenori TAKAHASHI, Anjo-city (JP); Eiji Masuda, Nagoya-city (JP)

(73) Assignee: DENSO CORPORATION, Kariya-city (JP)

(21) Appl. No.: 13/048,101

(22) Filed: Mar. 15, 2011

(30) Foreign Application Priority Data
Mar. 16, 2010 (JP) 2010-60013

(51) Int. Cl. B60L 1/00; H01H 47/22

(52) U.S. Cl. 307/9.1; 361/187

(57) ABSTRACT

A relay includes contacts, a driving coil, a moving part, and a resistor. The driving coil generates a magnetic force in accordance with a command signal. The moving part is configured to be driven by the magnetic force to open and close the contacts. The resistor has a predetermined electrical resistance. When the command signal is at a first level, the relay is set to a first on-state in which the contacts are closed through the resistor. When the command signal is at a second level higher than the first level, the relay is set to a second on-state in which the contacts are closed through the moving part without the resistor.

### CROSS REFERENCE TO RELATED APPLICATION

This application is based on Japanese Patent Application No. 2010-60013 filed on Mar. 16, 2010, the disclosure of which is incorporated herein by reference.

### FIELD OF THE INVENTION

The present invention relates to a relay for opening and closing an electric circuit and a power supply apparatus for a vehicle having the relay.

### BACKGROUND OF THE INVENTION

In recent years, the demand for hybrid vehicles, which uses an internal combustion engine and a motor generator, has grown to respond to social demands, such as low fuel consumption and low emission. FIG. 7 shows an example of a power supply apparatus (system) of a general hybrid vehicle.

The power supply apparatus has a direct-current power supply 1 such as a secondary battery, a smoothing capacitor 2, and an electrical load 3 used for driving a vehicle, such as a converter, an inverter or a motor generator. The smoothing capacitor 2 and the electrical load 3 are connected to the power supply 1. Further, a first main relay 4 and a second main relay 5 are connected at a positive end and a negative end of the power supply 1, respectively. A pre-charge circuit 6 for restricting a rush current is connected in parallel with the second main relay 5. In the pre-charge circuit 6, a pre-charge relay 7 and a limiting resistor 8 are connected in series.

On starting the power supply apparatus, an electric circuit is energized through the pre-charge circuit 6, so that a pre-charge for electrically charging the smoothing capacitor 2 is performed while restricting the rush current.

However, the power supply apparatus needs to have the pre-charge circuit 6, separately from the main relays, for restricting the rush current. Therefore, the number of components of the power supply apparatus increases, resulting in increases in size and manufacturing costs of the power supply apparatus.

For example, Japanese Patent Application Publication No. 2004-6084 describes a power supply device for solving such drawbacks. The described power supply device has a single relay, that is, a shutdown relay, which has a main relay function and a rush current restricting function. The shutdown relay has a movable contact as a first contact, fixed contacts as a second contact, a resistor fixed to the movable contact, and a driving mechanism for moving the movable contact and the resistor. The driving mechanism has a reciprocating member for reciprocating the movable contact and the resistor and a stopper for locking the movable contact at a predetermined position.

When the movable contact and the resistor are moved to a predetermined off-position by the reciprocating member and locked at the off-position by the stopper, the relay is in an off-state in which the movable contact and the resistor are separated from the fixed contacts. To switch the relay from the off-state to an on-state, first, the movable contact and the resistor are moved to a predetermined stop position by the reciprocating member, and locked at the stop position by the stopper. Thus, the relay is in a rush current restricting state in which the movable contact is connected to the fixed contacts through the resistor. As such, a rush current is restricted.

Thereafter, when the movable contact and the resistor are moved to a predetermined on-position by the reciprocating member and locked at the on-position by the stopper, the relay is in the on-state in which the movable contact is directly connected to the fixed contacts.

In the power supply apparatus, however, the relay has two driving sources, such as solenoids, for the reciprocating member and the stopper. Further, the states of the relay are switched by respectively controlling operations of the two driving sources. Therefore, the structure and control of the relay are complicated.

### SUMMARY OF THE INVENTION

The present invention is made in view of the foregoing matter, and it is an object of the present invention to provide a relay having a simple structure and controlled easily. It is another object of the present invention to provide a relay capable of contributing reductions of the number of components, size and manufacturing costs of an electric circuit.

According to an aspect, a relay includes contacts, a driving coil, a moving part, and a resistor. The driving coil generates a magnetic force in accordance with a command signal. The moving part is configured to be driven by the magnetic force to open and close the contacts. The resistor has a predetermined electrical resistance. The contacts are closed in a first on-state when the command signal is at a first level, and closed in a second on-state when the command signal is at a second level higher than the first level. In the first on-state, the contacts are closed through the resistor. In the second on-state, the contacts are closed through the moving part without the resistor.

In the relay, operation states, such as the first on-state and the second on-state, are switched by simply changing the command signal to the single driving coil as the driving source. Therefore, the structure and the control of the relay can be simplified.

The relay can be employed to open and close an electric circuit. For example, on closing the electric circuit, that is, on energizing the electric circuit, the relay can be first operated to the first on-state and then switched to the second on-state. That is, in the first on-state, because the electric circuit is energized through the resistor, a rush current is restricted. Thereafter, the electric circuit is switched to a normal energized state by switching the relay to the second on-state in which the contacts are closed without the resistor. That is, the single relay has a main relay function and a rush current restricting function. Accordingly, the relay contributes to reduce the number of components and the size of the electric circuit. Further, the relay contributes to reduce the manufacturing costs of the electric circuit.

For example, the relay can be employed to a power supply apparatus for a vehicle. In an electric circuit of the power supply apparatus, a smoothing capacitor and an electrical load of the vehicle are connected to a direct-current power supply through the relay. In such a case, the power supply apparatus does not need a pre-charge circuit for restricting the rush current. Therefore, the number of components of the power supply apparatus reduces. Further, the size and the manufacturing costs of the power supply apparatus reduce.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic diagram of a power supply apparatus for a hybrid vehicle, having a relay according to a first embodiment of the present invention;

FIG. 2A is a schematic diagram of the relay, in an off-state, according to the first embodiment;

FIG. 2B is a schematic diagram of the relay, in a first on-state, according to the first embodiment;

FIG. 2C is a schematic diagram of the relay, in a second on-state, according to the first embodiment;

FIG. 3 is a flowchart showing a control routine of the relay according to the first embodiment;

FIG. 4A is a schematic diagram of a relay, in an off-state, according to a second embodiment of the present invention;

FIG. 4B is a schematic diagram of the relay, in a first on-state, according to the second embodiment;

FIG. 4C is a schematic diagram of the relay, in a second on-state, according to the second embodiment;

FIG. 5 is a schematic cross-sectional view of a part of a relay according to a modification of the first and second embodiments;

FIG. 6A is a schematic diagram of a relay, in an off-state, according to a third embodiment of the present invention;

FIG. 6B is a schematic diagram of the relay, in a first on-state, according to the third embodiment;

FIG. 6C is a schematic diagram of the relay, in a second on-state, according to the third embodiment; and

FIG. 7 is a schematic diagram of an example of a power supply apparatus for a general hybrid vehicle.

### DETAILED DESCRIPTION OF EXEMPLARY EMBODIMENTS

Exemplary embodiments will be described hereinafter with reference to the drawings. The embodiments are exemplarily employed in a power supply apparatus (system) of a hybrid vehicle.

### First Embodiment

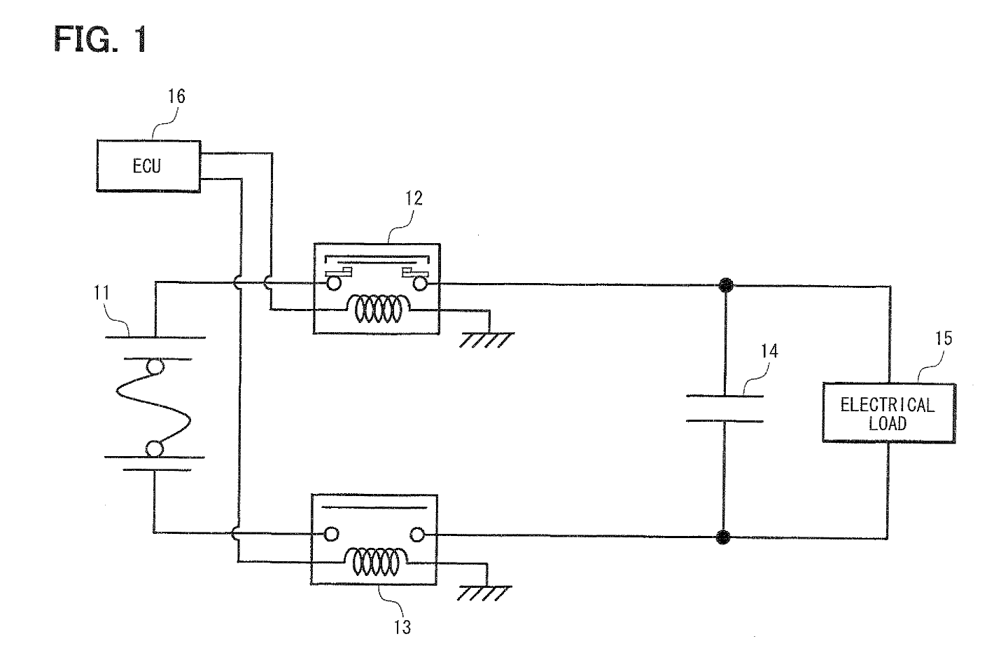

A first embodiment will be described with reference to FIGS. 1 through 3. First, a general structure of a power supply apparatus of a hybrid vehicle will be described.

Referring to FIG. 1, a direct-current power source 11, also referred to as a battery, is for example, constructed of a secondary battery. A smoothing capacitor 14 and an electrical load 15 are connected to the power source 11 through a three-mode relay 12 and a main relay 13. The electrical load 15 is a device used for driving the hybrid vehicle. The electrical load 15 is, for example, a converter, an inverter, and/or a motor generator.

For example, the three-mode relay 12 is connected to a positive end of the power supply 11, and the main relay 13 is connected to a negative end of the power supply 11. Alternatively, the main relay 13 may be connected to the positive end of the power supply 11, and the three-mode relay 12 may be connected to the negative end of the power supply 11. Operations of the three-mode relay 12 and the main relay 13 are controlled by an electronic control circuit (ECU) 16.

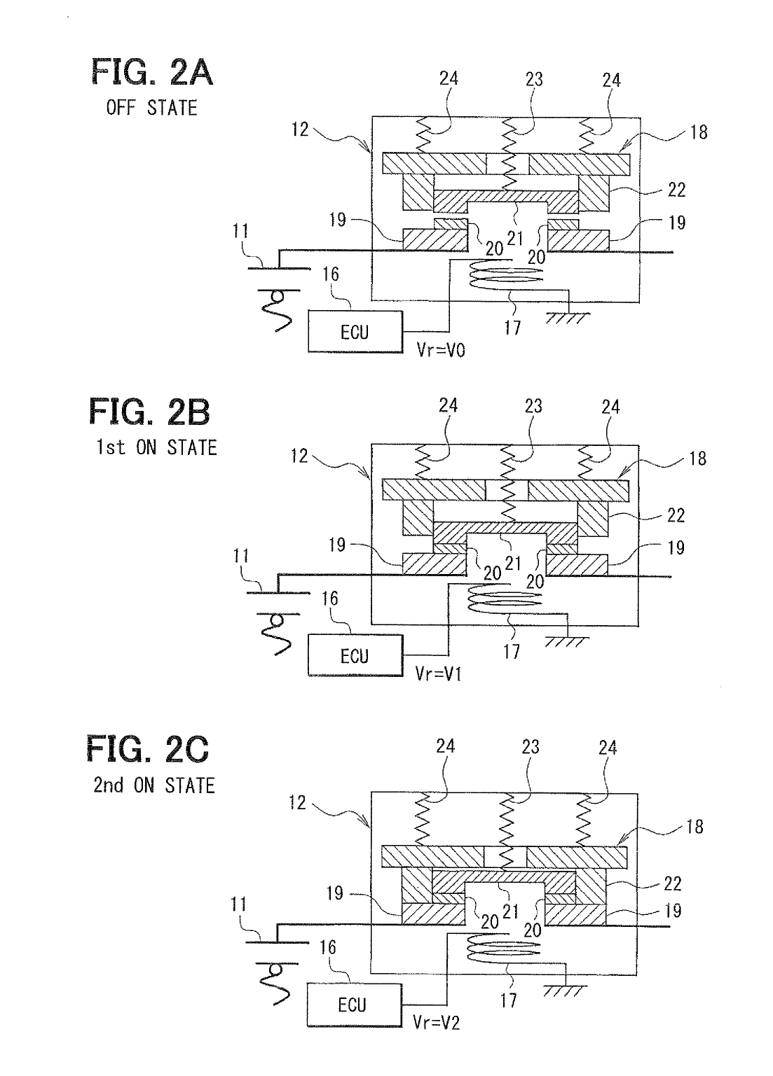

Next, a structure of the three-mode relay 12 will be described with reference to FIGS. 2A through 2C.

The three-mode relay 12 includes a driving coil 17, a moving part (needle) 18, and a pair of contacts 19. The driving coil 17 generates a magnetic force in accordance with a command signal indicative of a relay-on voltage Vr, outputted from the ECU 16. The moving part 18 is driven in response to the magnetic force. The pair of contacts 19 is opened and closed by the moving part 18.

The three-mode relay 12 further includes contact resistors 20. The contact resistor 20 is fixed on a part of an upper surface of each contact 19, the upper surface providing a contact surface. The contact resistor 20 is fixed in a condition of being electrically connected to the contact 19. The contact resistor 20 is made of a resistive member having a predetermined electrical resistance for restricting a rush current.

The moving part 18 includes a first moving member 21 and a second moving member 22, which are movable separately from each other. The first moving member 21 and the second moving member 22 are respectively biased in a direction separating from the contacts 19 by means of biasing members 23, 24 such as springs.

The first moving member 21 has a shape that is capable of electrically connecting between the contact resistors 20 when brought into contact with the contact resistors 20. The second moving member 22 has a shape that is capable of electrically connecting between the contacts 19 when brought into contact with the portions of the contacts 19 other than the contact resistors 20.

The electrical connection between the contacts 19 can be made at least in two states by appropriately adjusting materials, weights and shapes of the first and second moving members 21, 22, biasing forces of the biasing members 23, 24, such as spring constants, the magnetic force of the driving coil 17, and the like. That is, the first and second moving members 21, 22, the biasing members 23, 24 and the driving coil 17 are configured such that, when the magnetic force generated by the driving coil 17 is equal to or lower than a predetermined value, the first moving member 21 is moved toward the contact resistors 20 and is brought into contact with the contact resistors 20, and when the magnetic force is greater than the predetermined value, the second moving member 22 is moved toward the contacts 19 and is brought into contact with the contacts 19.

The first moving member 21 is, for example, made of a magnet. The second moving member 22 is, for example, made of iron.

For example, the first moving member 21 has a generally U-shape, and provides contact surfaces to contact with the contact resistors 20 at ends of the generally U-shape. Thus, the first moving member 21 allows electrical connection between the contacts 19 through the contact resistors 20.

For example, the second moving member 22 has a generally U-shaped cross-section, and provides contact surfaces to contact with the contacts 19 at the ends thereof. Thus, the second moving member 22 allows electrical connection between the contacts 19 without using the contact resistors 20.

As shown in FIG. 2A, when the relay-on voltage Vr impressed to the driving coil 17 is at an off-level V0 (e.g., 0V), the driving coil 17 does not generate a magnetic force. Therefore, the first moving member 21 and the second moving member 22 are held at off-positions away from the contacts 19 and the contact resistors 20 by means of the biasing forces of the biasing members 23, 24. Thus, the three-mode relay 12 is held in an off-state in which the contacts 19 are open, that is, in a de-energized state.

As shown in FIG. 2B, when the relay-on voltage Vr is at a first on-level V1 (e.g., 5V), the driving coil 17 generates a first magnetic force that is equal to or lower than the predetermined level. Therefore, the first moving member 21 is moved toward the contact resistors 20 and is brought into contact with the contact resistors 20. As such, the three-mode relay 12 is switched to a first on-state in which the first moving member 21 closes the contacts 19 through the contact resistors 20.

As shown in FIG. 2C, when the relay-on voltage Vr is at a second on-level V2 (e.g., 12V) that is higher than the first on-level, the driving coil 17 generates a second magnetic force that is greater than the predetermined value. Therefore, the second moving member 22 is moved toward the contacts 19 and is brought into contact with the contacts 19. As such, the three-mode relay 12 is switched to a second on-state in which the second moving member 22 closes the contacts 19 without using the contact resistors 20, that is, directly closes the contacts 19.

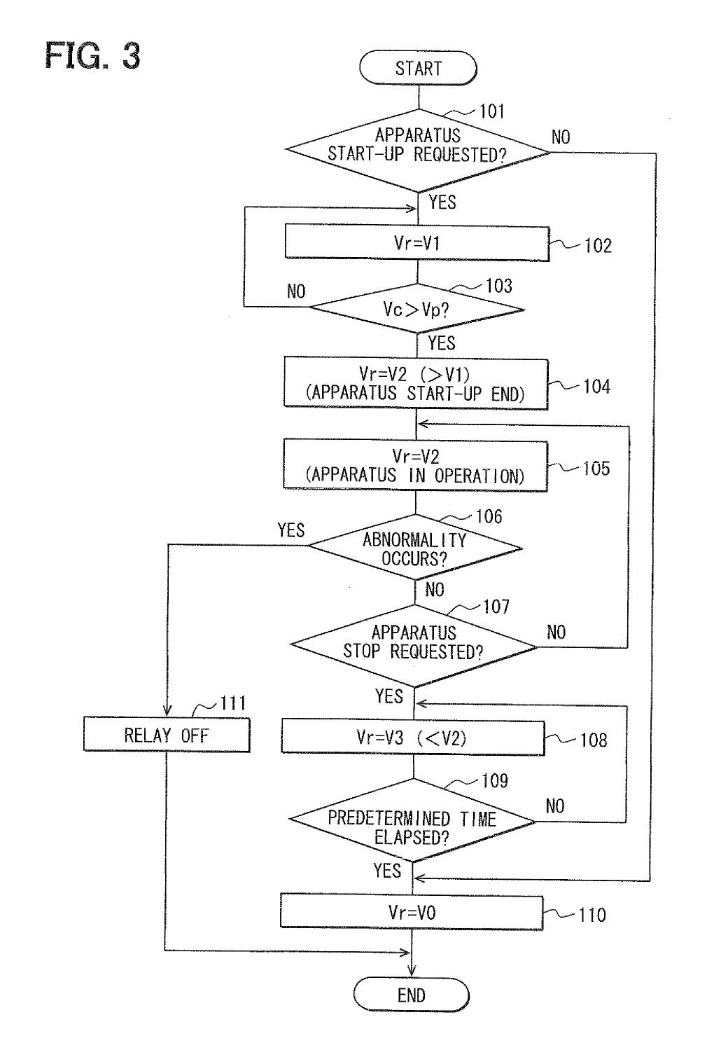

The ECU 16 controls the operation of the three-mode relay 12 by executing a relay control routine shown in FIG. 3. Hereinafter, a processing of the relay control routine executed by the ECU 16 will be described.

The relay control routine shown in FIG. 3 is periodically repeated while the ECU 16 is in operation. First, in a step 101, it is determined whether or not a start-up of the power supply apparatus is requested. When it is determined that the start-up is not requested, in a step 111, the relay-on voltage Vr is maintained at the off-level V0 so that the three-mode relay 12 is maintained in the off-state.

When it is determined that the start-up of the power supply apparatus is requested in the step 101, the relay-on voltage Vr is changed to the first on-level V1 (e.g., 5V) in a step 102. Thus, the three-mode relay 12 is switched to the first on-state in which the first moving member 21 closes the contacts 19 through the contact resistors 20. At this time, the main relay 13 is also switched to an on-state, that is, in an energized state. As such, an electric circuit of the power supply apparatus is energized through the contact resistors 20, and a pre-charge for electrically charging the smoothing capacitor 14 is performed while restricting a rush current at the time of starting the power supply apparatus.

In a step 103, it is determined whether or not a capacitor voltage Vc, that is, a voltage between terminals of the smoothing capacitor 14 is higher than a predetermined voltage Vp. When it is determined that the capacitor voltage Vc is equal to or lower than the predetermined voltage Vp, the processing returns to the step 102. Thus, the relay-on voltage Vr is maintained at the first on-level V1 to maintain the three-mode relay 12 in the first on-state.

When it is determined that the capacitor voltage Vc is higher than the predetermined voltage Vp in the step 103, the processing proceeds to a step 104. In the step 104, the relay-on voltage Vr is switched to the second on-level V2 (e.g., 12V) that is higher than the first on-level V1. Thus, the three-mode relay 12 is switched to the second on-state in which the second moving member 22 closes the contacts 19 without through the contact resistors 20, that is, the second moving member 22 directly closes the contacts 19.

Therefore, the power supply apparatus is switched to a normal energized state in which the electric circuit is energized without through the contact resistors 20. In this way, the start-up of the power supply apparatus is finished. Then, the processing proceeds to a step 105.

During the operation of the power supply apparatus, the relay-on voltage Vr is maintained at the second on-level V2. Thus, the three-mode relay 12 is maintained in the second on-state.

In a step 106, it is determined whether or not an abnormality occurs in the power supply apparatus. For example, the occurrence of abnormality is determined based on an abnormality diagnosis result obtained by a non-illustrated abnormality diagnosing routine. When it is determined that there is no abnormality in the power supply apparatus, that is, the power supply apparatus is in a normal condition, the processing proceeds to a step 107. In the step 107, it is determined whether or not a stop command for stopping the power supply apparatus is generated.

When it is determined that the stop command is not generated in the step 107, the processing returns to the step 105. Thus, the relay-on voltage Vr is maintained at the second on-level V2 to keep the three-mode relay 12 in the second on-state.

When it is determined that the stop command is generated in the step 107, the processing proceeds to a step 108. In the step 108, the relay-on voltage Vr is changed to a third on-level V3 that is lower than the second on-level V2. The third on-level V3 is same as or approximately same as the first on-level V1. Thus, the three-mode relay 12 is switched to the first on-state in which the first moving member 21 closes the contacts 19 through the contact resistors 20.

Then, in a step 109, it is determined whether a predetermined period has elapsed since the relay-on voltage Vr was changed to the third on-level V3. When it is determined that the predetermined period has elapsed, the processing proceeds to a step 110. In the step 110, the relay-on voltage Vr is changed to the off-level V0. Thus, the three-mode relay 12 is switched to the off-state.

In this way, on turning off the three-mode relay 12, the three-mode relay 12 is first switched to the first on-state to reduce the electric current passing through the electric circuit, and then switched to the off-state. Therefore, arcing is reduced, and hence the life of the three-mode relay 12 improves.

When it is determined that the power supply apparatus has an abnormality in the step 106, the processing proceeds to a step 111 to change a way of turning off the three-mode relay 12 depending on the type of abnormality. For example, in a case of abnormality where the electric circuit of the power supply apparatus needs to be immediately de-energized, the relay-on voltage Vr is switched from the second on-level V2 to the off-level V0. Thus, the three-mode relay 12 is immediately switched to the off-state. In a case of abnormality where the electric circuit of the power supply apparatus needs not to be immediately de-energized, the relay-on voltage Vr is first switched from the second on-level V2 to the third on-level V3, and then switched to the off-level V0. Thus, the three-mode relay 12 is switched from the second on-state to the first on-state, then to the off-state. As such, arcing is reduced.

In the present embodiment, on starting the power supply apparatus, that is, on energizing the electric circuit of the power supply apparatus, the relay-on voltage Vr is first set to the first on-level V1 to make the three-mode relay 12 in the first on-state. Thus, the electric circuit is energized through the contact resistors 20. Accordingly, the pre-charge for electrically charging the smoothing capacitor 14 can be performed while restricting the rush current at the time of staring the power supply apparatus. Thereafter, the relay-on voltage Vr is switched to the second on-level V2 to make the three-mode relay 12 in the second on-state in which the second moving member 22 closes the contacts 19 without through the contact resistors 20. That is, the power supply apparatus is switched to the normal energized state in which the electric circuit is energized without the contact resistors 20.

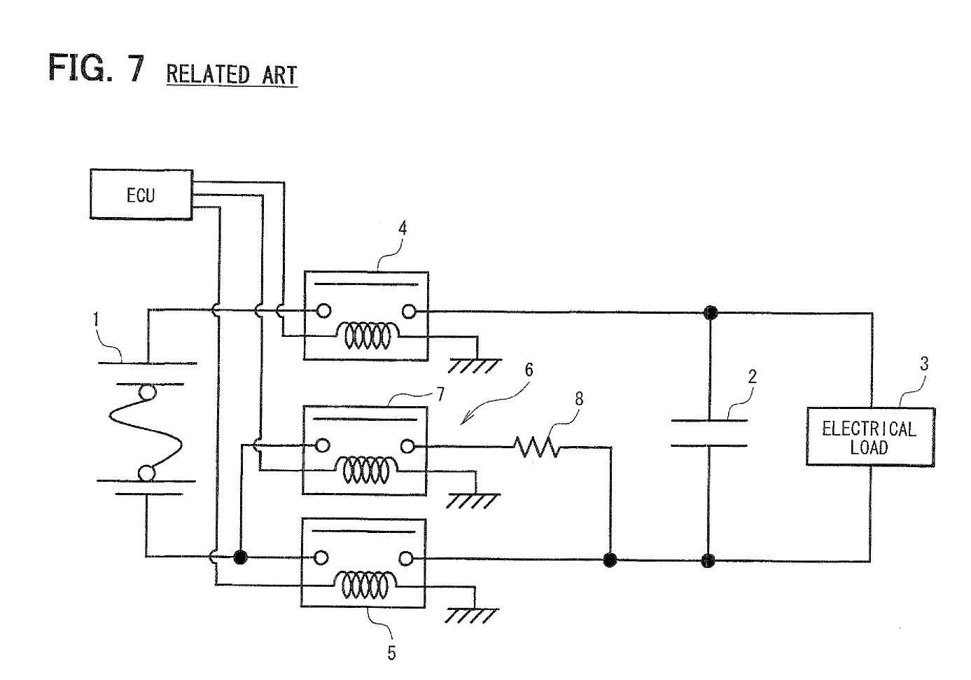

In this way, because the single relay 12 has a main relay function as well as a rush current restricting function, the power supply apparatus needs not to have a separate pre-charge circuit for restricting the rush current. That is, the pre-charge circuit in which the pre-charge relay and the limiting resistor are connected in series, as shown in FIG. 7, is not necessary. Therefore, the number of components of the power supply apparatus can be reduced. Further, the size of the power supply apparatus can be reduced. Moreover, the manufacturing costs can be reduced.

In addition, the three-mode relay 12 can be switched to at least two on-states only by changing the voltage level impressed to the single driving coil 17 as the driving source. Therefore, the structure and control of the three-mode relay 12 can be simplified, as compared with the conventional relay having the two driving sources, which are separately controlled to switch the on-state thereof.

Further, the moving part 18 includes the first moving member 21 and the second moving member 22, which are movable separately from each other. The first moving member 21 is brought into contact with the contact resistors 20 when the relay-on voltage Vr is at the first on-level V1 so as to make the three-mode relay 12 in the first on-state. The second moving member 22 is brought into contact with the contacts 19 when the relay-on voltage Vr is at the second on-level V2 so as to switch the three-mode relay 12 to the second on-state. Accordingly, the first on-state and the second on-state can be properly switched by the first moving member 21 and the second moving member 22.

### Second Embodiment

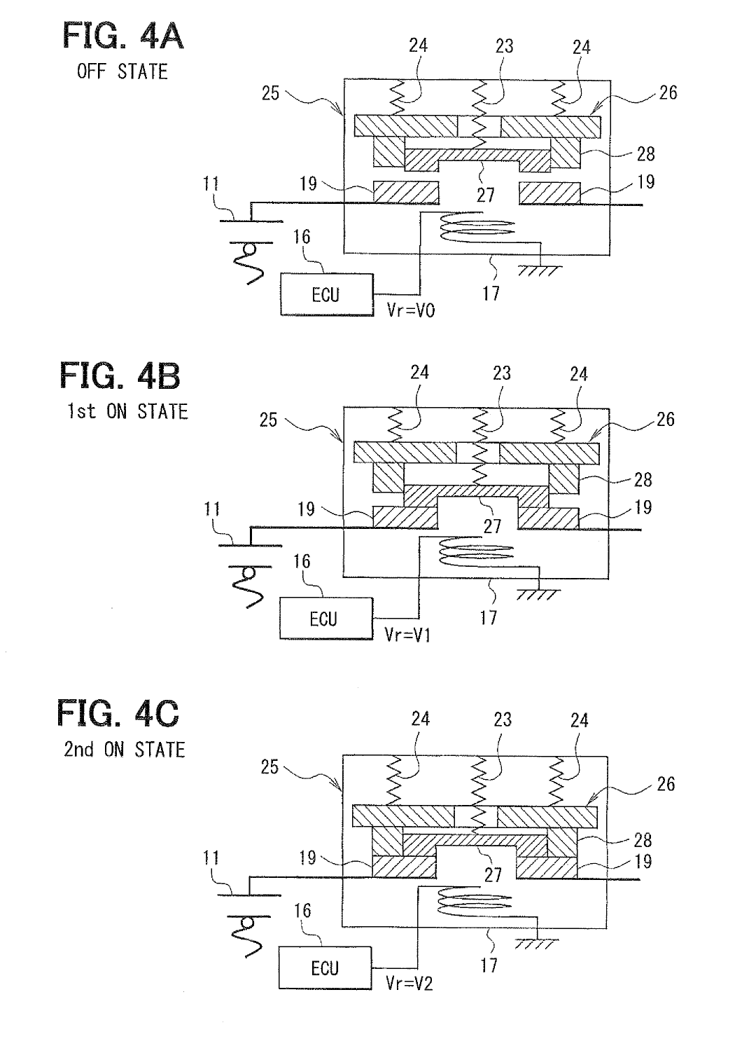

A second embodiment of the present invention will be described with reference to FIGS. 4A through 4C. Hereinafter, like parts are denoted with like reference numbers, and a description thereof will not be repeated. Structures different from the first embodiment will be mainly described.

Referring to FIGS. 4A through 4C, in a three-mode relay 25 according to the second embodiment, a moving part 26 includes a first moving member 27 and a second moving member 28, which are movable separately from each other. The first moving member 27 is made of a resistive member having a predetermined resistance necessary for restricting a rush current, as the resistor. Thus, the three-mode relay 25 does not have the contact resistors 20 of the first embodiment.

The first moving member 27 has a shape that is capable of electrically connecting the contacts 19 when brought into contact with portions of the contacts 19. The second moving member 28 has a shape that is capable of electrically connecting the contacts 19 when brought into contact with portions of the contacts 19 other than the portions to which the first moving member 27 contacts.

As shown in FIG. 4A, when the relay-on voltage Vr is at the off-level V0, the driving coil 17 does not generate a magnetic force. Therefore, the first moving member 27 and the second moving member 28 are held at off-positions away from the contacts 19 by means of the biasing forces of the biasing members 23, 24. Thus, the three-mode relay 25 is held in the off-state in which the contacts 19 are open, that is, in the de-energized state.

As shown in FIG. 4B, when the relay-on voltage Vr is at the first on-level V1, the driving coil 17 generates the first magnetic force that is equal to or lower than the predetermined value. Thus, the first moving member 27 is moved toward the contacts 19 and brought into contact with the contacts 19. Therefore, the three-mode relay 25 is switched to the first on-state in which the contacts 19 are closed through the first moving member 27 as the resistor.

As shown in FIG. 4C, when the relay-on voltage Vr is at the second on-level V2, which is higher than the first on-level V1, the driving coil 17 generates the second magnetic force that is higher than the predetermined value. Thus, the second moving member 28 is moved toward the contacts 19 and brought into contact with the contacts 19. Therefore, the three-mode relay 25 is switched to the second on-state in which the contacts 19 are closed through the second moving member 28, without the first moving member 27 as the resistor.

In the present embodiment, the first moving member 27 is constructed of the resistive member. The three-mode relay 25 is switched to the first on-state by bringing the first moving member 27 to the contacts 19 when the relay-on voltage Vr is at the first on-level V1. Also, the three-mode relay 25 is switched to the second on-state by bringing the second moving member 28 to the contacts 19 when the relay-on voltage Vr is at the second on-level V2. Therefore, the first moving member 27 can also serve as the resistor. Accordingly, the number of components of the three-mode relay 25 can be reduced. Further, the size and the manufacturing costs of the three-mode relay 25 can be reduced.

In the three-mode relays 12, 25 of the first and second embodiments, the second moving member 22, 28 and the contacts 19 have substantially flat contact surfaces. Alternatively, the contact surfaces of the second moving member 22, 28 and the contacts 19 can have other shapes.

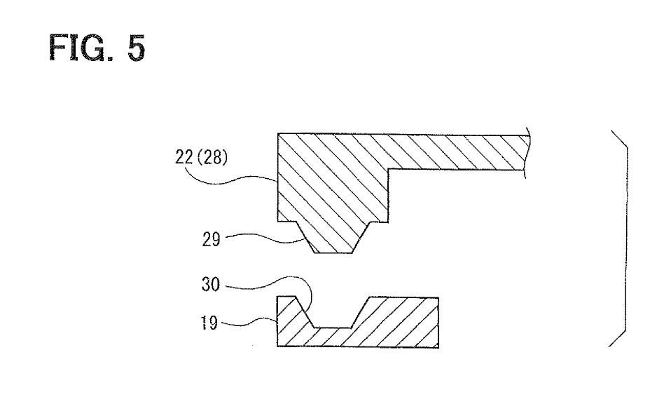

For example, as shown in FIG. 5, the second moving member 22, 28 has a projection 29 including tapered surfaces at each contact surface thereof, and each of the contacts 19 has a recess 30 having tapered surfaces at the contact surface thereof to accord with the shape of the projection 29. In this case, the projection 29 of the second moving member 22, 28 is received in the recess 30 of the contact 19 to make contact between the second moving member 22, 28 and the contact 19.

As another example, the second moving member 22, 28 may have the recess 30 at each contact surface thereof, and the contact 19 may have the projection 29 at the contact surface thereof. In this case, the projection 29 of the contact 19 is received in the recess 30 of the second moving member 22, 28 to make contact between the second moving member 22, 28 and the contact 19. In these cases, the contact areas between the second moving member 22, 28 and the contacts 19 can be increased. Thus, the electrical contact between the second moving member 22, 28 and the contacts 19 improves.

### Third Embodiment

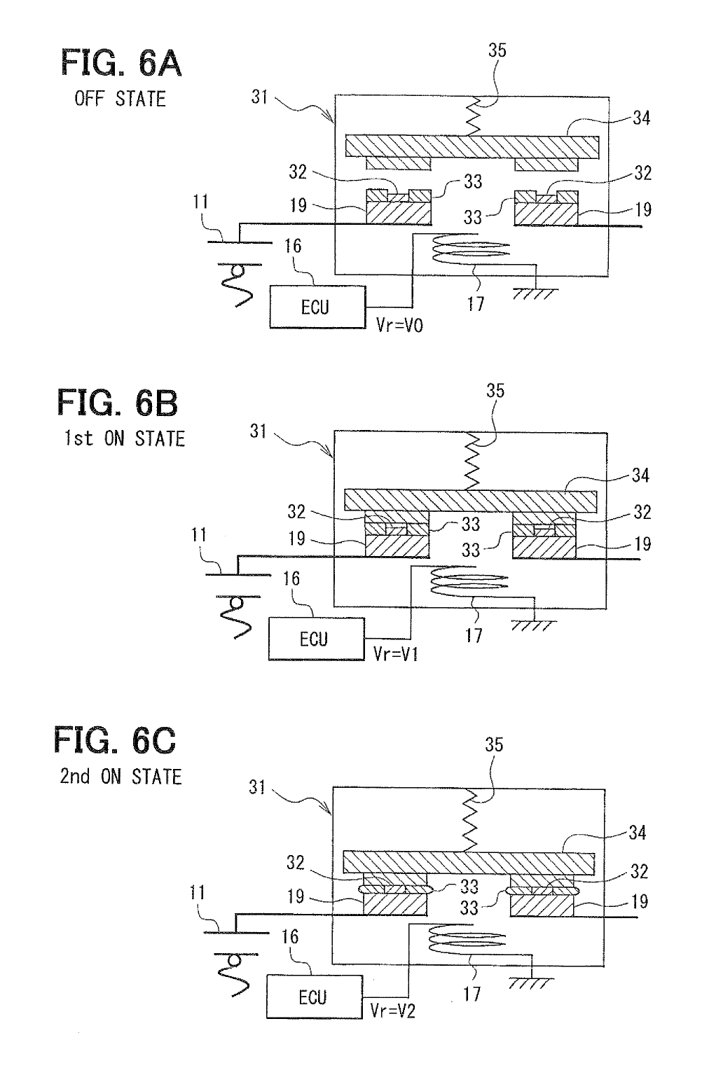

A third embodiment of the present invention will be described with reference to FIGS. 6A to 6C. Hereinafter, like parts are denoted with like reference numbers, and a description thereof will not be repeated. Structures different from the first embodiment will be mainly described.

Referring to FIGS. 6A through 6C, in a three-mode relay 31 according to the second embodiment, each of the contacts 19 is formed with a contact projection 32 on an upper surface thereof. The contact projection 32 is formed at a portion of the upper surface of the contact 19 and projects upwardly, that is, toward a moving part 34. For example, the contact projection 32 is located at a middle position of the upper surface of the contact 19.

Further, a contact resistor 33 as the resistor is fixed to the upper surface of the contact 19 in an electrically connected state. The contact resistor 33 is disposed to surround the contact projection 32. The contact resistor 33 is made of a resistive member having a predetermined electrical resistance necessary for restricting a rush current. Further, the contact resistor 33 is made of an elastically deformable member, such as a rubber, a thermoplastic elastomer, or the like.

A thickness of the contact resistor 33 is greater than a height of the contact projection 32 in a direction perpendicular to the upper surface of the contact 19. Therefore, an upper end of the contact resistor 33 is located higher than an upper end of the contact projection 32. The three-mode relay 31 has the single moving member 34 as the moving part. The moving member 34 is biased in a direction away from the contacts 19 by means of a biasing member 35, such as a spring.

As shown in FIG. 6A, when the relay-on voltage Vr is at the off-level V0, the driving coil 17 does not generate a magnetic force. Therefore, the moving member 34 is held at the off-position away from the contacts 19 and the contact resistors 33 by a biasing force of the biasing member 35. Thus, the three-mode relay 31 is maintained in the off-state in which the contacts 19 are open, that is, in the de-energized state.

As shown in FIG. 6B, when the relay-on voltage Vr is at the first on-level V1, the driving coil 17 generates the first magnetic force that is lower than the predetermined force. Therefore, the moving member 34 is moved toward the contacts 19 and brought into contact with the contact resistors 33. Thus, the three-mode relay 31 is switched to the first on-state in which the moving member 34 closes the contacts 19 through the contact resistors 33.

As shown in FIG. 6C, when the relay-on voltage Vr is at the second on-level V2, which is higher than the first on-level V1, the driving coil 17 generates the second magnetic force that is higher than the predetermined value. Therefore, the moving member 34 is further moved toward the contacts 19. In this case, the moving member 34 is brought into contact with the contact projections 32 while elastically deforming, that is, compressing the contact resistors 33. Thus, the three-mode relay 31 is switched to the second on-state in which the moving member 34 closes the contacts 19 without the contact resistors 33, that is, the moving member 34 directly closes the contacts 19.

In the present embodiment, at least two on-states of the three-mode relay 31 can be switched by the single moving member 34. Therefore, the number of components of the relay 31 can be reduced. Further, the size and the manufacturing costs of the relay 31 can be reduced.

In the first to third embodiments, the three-mode relay 12, 25, 31 is connected to one of the positive end and the negative end of the power source 11, and the main relay is connected to the other one of the positive end and the negative end of the power source 11. Alternatively, the main relay can be omitted, and the three-mode relay can be connected to one of the positive end and the negative end of the power source 11.

The shapes and arrangements of components of the three-mode relay 12, 25, 31, such as the moving members 18, 21, 22, 26, 27, 28, 34, the contacts 19, the contact resistors 20, 33, may be modified in various other ways.

In the first to third embodiments, the three-mode relays 12, 25, 31 are exemplarily employed in the power supply apparatus of the hybrid vehicle. However, the three-mode relays 12, 25, 31 can be employed to any other purposes. For example, the three-mode relays 12, 25, 31 can be employed to a power supply apparatus of an electric vehicle using a motor as the driving source. Further, the three-mode relays 12, 25, 31 can be employed in various electric circuits other than the electric circuit of the power supply apparatus for the vehicles.

Additional advantages and modifications will readily occur to those skilled in the art. The invention in its broader term is therefore not limited to the specific details, representative apparatus, and illustrative examples shown and described.

What is claimed is:

1. A relay for opening and closing an electric circuit, comprising:
a plurality of contacts;
a driving coil that generates a magnetic force in accordance with a command signal;
a moving part configured to be driven by the magnetic force to open and close the contacts; and
a resistor having a predetermined electrical resistance, wherein
the contacts are closed in a first on-state when the command signal is at a first level, and closed in a second on-state when the command signal is at a second level higher than the first level,
in the first on-state, the contacts are closed through the resistor, and
in the second on-state, the contacts are closed through the moving part without the resistor.

2. The relay according to claim 1, wherein
the moving part includes a first moving member and a second moving member, which are movable separately from each other,
the resistor is disposed on each of the contacts,
in the first on-state, the first moving member is brought into contact with the resistor to close the contacts through the resistor, and
in the second on-state, the second moving member is brought into direct contact with portions of the contacts other than the resistor.

3. The relay according to claim 1, wherein
the moving part includes a first moving member and a second moving member, which are movable separately from each other,
the first moving member is constructed of the resistor,
in the first on-state, the first moving member is brought into contact with the contacts to close the contacts, and
in the second on-state, the second moving member is brought into contact with the contacts to close the contacts.

4. The relay according to claim 1, wherein
each of the contacts has a projection at a portion of a contact surface that faces the moving part,
the resistor is made of an elastically deformable member and is disposed on the contact surface of each of the contacts adjacent to the projection,
an end of the resistor is located closer to the moving part than an end of the projection,
in the first on-state, the moving part is brought into contact with the resistor to close the contacts through the resistor, and
in the second on-state, the moving part is brought into direct contact with the projection while compressing the resistor to close the contacts.

5. A power supply apparatus for a vehicle, comprising:
a direct-current power supply;
a smoothing capacitor;
an electrical load of the vehicle; and
the relay according to claim 1, wherein
the smoothing capacitor and the electrical load are connected to the direct-current power supply through the relay.

6. The power supply apparatus according to claim 5, further comprising:
means for setting the command signal to the first level to start an operation of the power supply apparatus so that the relay is switched to the first on-state and a pre-charge for electrically charging the smoothing capacitor is performed, and
means for setting the command signal to the second level to switch the relay to the second on-state.
